(19) United States
(12) Patent Application Publication
(10) Pub. No.: US 2007/0204680 A1
(43) Pub. Date: Sep. 6, 2007

(54) Measuring device for indicating the tractive condition of a surface

(76) Inventor: Russell Craig Holt, Delavan, IL (US)

Correspondence Address: Russell Craig Holt, PO Box 733, Delavan, IL, 61734, US

(21) Appl. No.: 11/714,646

(22) Filed: Mar. 6, 2007

Related U.S. Application Data
(60) Provisional application No. 60/779,608, filed on Mar. 6, 2006.

(51) Int. Cl. B23Q 17/09

(52) U.S. Cl. 73/104

(57) ABSTRACT

The present invention provides an apparatus adapted to engage a surface, such as a road or racetrack. The apparatus provides an output to an operator that is representative of the current tractive condition of the surface. The indication from the measuring device may be adapted to provide a quantifiable indication to a driver or crew related to recent changes in the tractive condition of the surface. The driver or crew may in turn configure aspects of a racing vehicle, driving methodology and performance expectations based on current and measurable surface conditions.

The present application claims the benefit of previously filed U.S. Provisional Application Ser. No. 60/779,608 filed Mar. 6, 2006 and is incorporated herein by reference.

### TECHNICAL FIELD

This invention relates generally to an apparatus adapted to indicate the tractive condition of a surface, and more particularly to an apparatus adapted to provide a quantifiable indication relative to periodic changes in the tractive condition of the surface.

### BACKGROUND

Various sports, such as sports car, motorcycle and bicycle racing, are impacted to a large degree by the condition of the track surface that is being raced on. More specifically, the ability of the tires to engage and hold the track surface continuously changes. This continuous change often creates a need to make adjustments to the tire pressure, suspension system and chassis of the car or cycle. Additionally, in some racing activities the racer is required to make a prediction related to how fast he expects to finish the race. Based upon the accuracy of the prediction, the outcome of the race may be adjusted, similar to a handicap system.

Currently drivers must rely on imperfect methods of determining the condition of a racing surface. One such method utilizes a crewmember to drag his or her foot along a portion of the race surface, afterward formulating an estimation, relative to the condition of the surface. The crewmember must then communicate the results of this imprecise estimation to the driver or other crewmembers.

It would be desirable to provide racers with a method of analyzing the condition of the racing surface and further provide a consistent yet quantifiable measurement related to the current condition of the racing surface.

U.S. Pat. No. 5,814,718 to Andresen et al discloses a method and apparatus for controlling friction between the tires of a vehicle and a road surface. The apparatus utilizes a plurality of mathematical curves to calculate maximum friction and in turn controls the vehicle through a means to prevent slip related to braking or acceleration. This method of controlling slip is typically not permitted during sanctioned race activities. It would be desirable to provide a quantifiable and consistent method to analyze surface conditions

The present invention is directed to overcoming one or more of the above identified problems.

### SUMMARY OF THE INVENTION

In one embodiment of the present invention, an apparatus is provided to engage with a surface, such as a road or a race surface. A contact portion of the apparatus is moved along the surface by a mechanical force. An indicator is adapted to display a value related to the amount of force required to move the contact portion in relation to the surface.

In another embodiment of the present invention, a method of determining the condition of a racing surface is provided. The method includes the steps of applying a measuring device to the surface, moving a contact portion of the measuring device in relation to the surface and observing an indication related to the condition of the surface.

### BRIEF DESCRIPTION OF THE DRAWINGS

FIG. 1 is a sectional elevation view of a measuring device having a pair of contact levers biased against a surface.

FIG. 2 is a sectional elevation view of the measuring device wherein the contact levers have been displaced in relation to the surface.

FIG. 3 is an isometric sectional view of the present invention illustrating a contact assembly adapted to engage a surface.

FIG. 4 is a hydraulic circuit adapted to actuate the measuring device and provide an indication of the condition of the surface.

### DETAILED DESCRIPTION

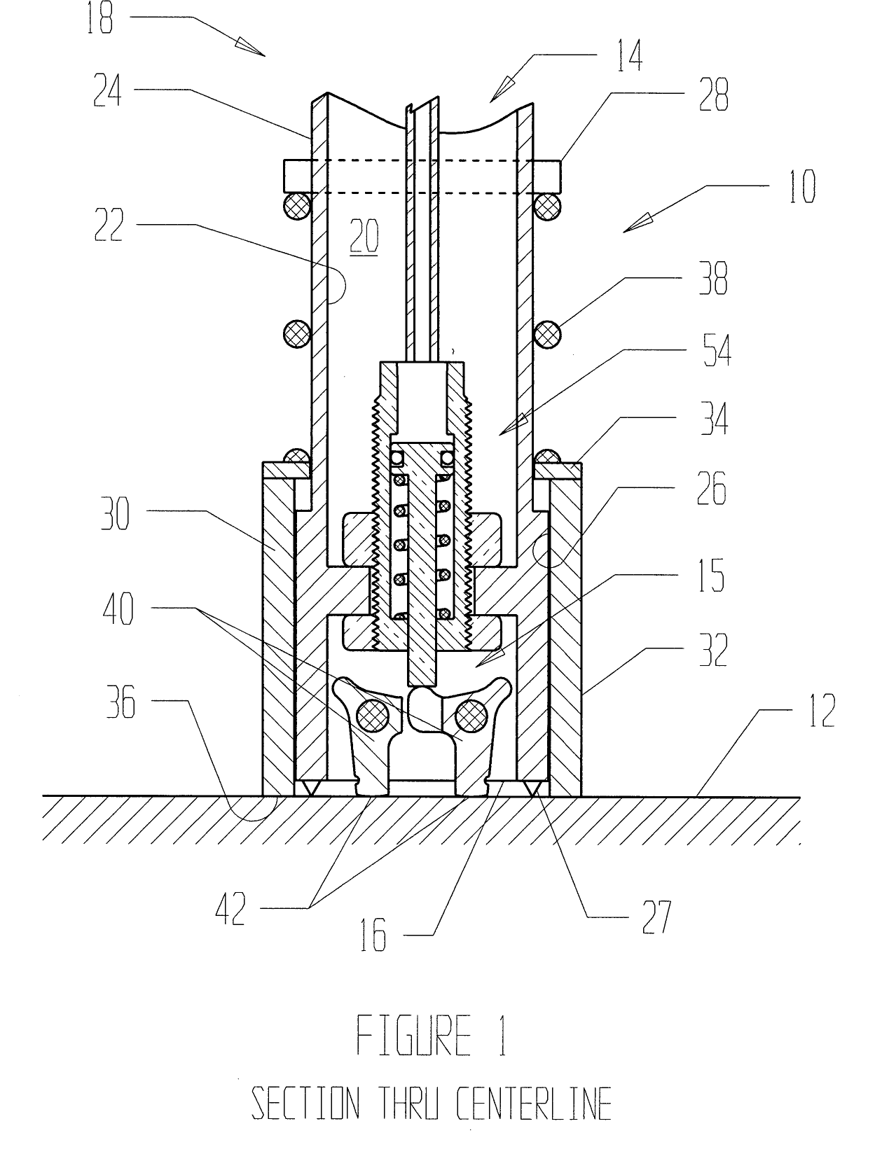

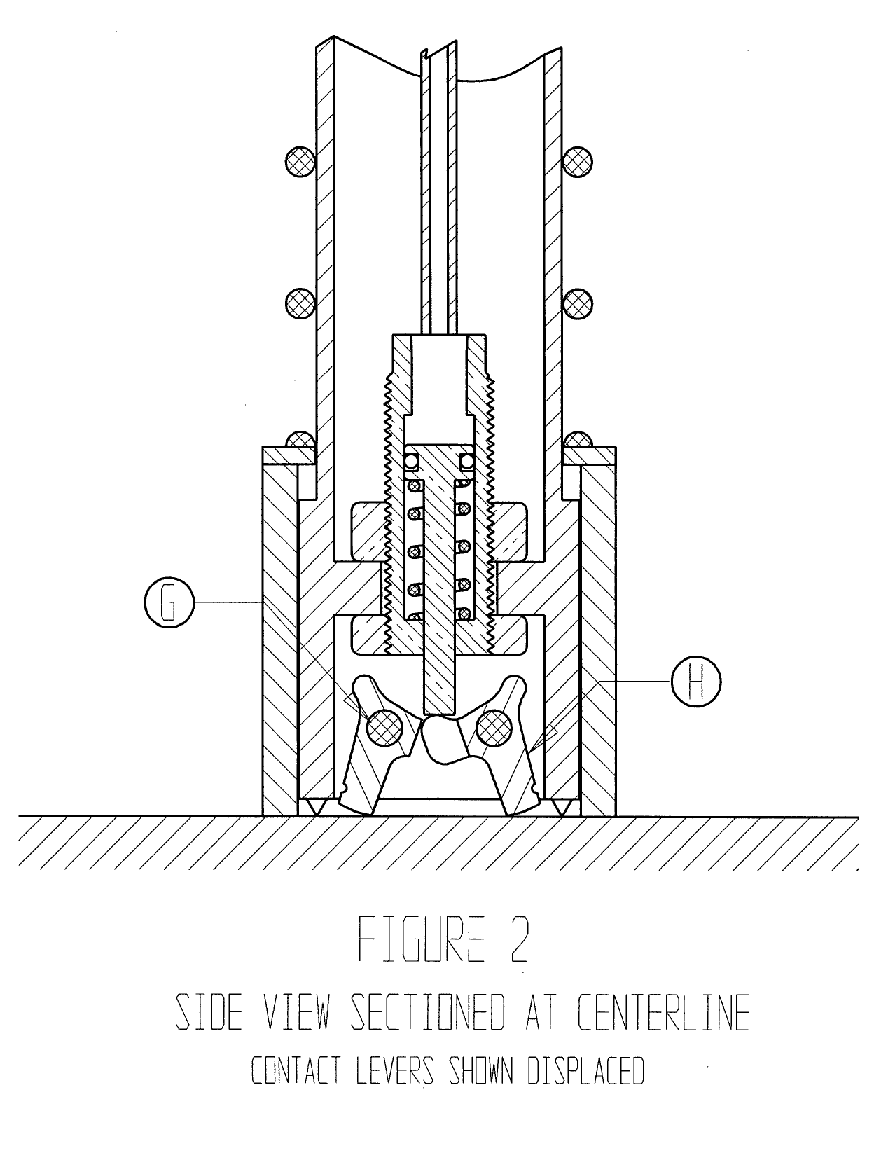

Referring to FIG. 1 and 2, by way of example of a measuring device 10 is shown. Measuring device 10 is adapted to indicate a tractive condition of a surface 12, such as a road or racetrack. The measuring device 10 includes a housing 14 adapted to contain a contact assembly 15 of the measuring device 10. The housing 14 as illustrated, is a substantially cylindrical member, although it should be understood that numerous other forms may be suitably adapted to hold the contact assembly for its intended purpose. The housing 14 includes a first end portion 16, a second end portion 18 and a body 20 extending between the first and second end portions 16,18. The body 20 is shown for example as being an annular member and includes an interior surface 22 and an exterior surface 24. A plurality of protrusions 27 extend from the first end portion 16 in a direction away from the second end portion 18. The protrusions 27 are adapted to prevent movement of the first end portion 16 in relation to the surface 12 when the measuring device is being actuated. The exterior surface 24 of the body 20 has a stepped outer diameter and forms a stop ring 26 extending along the exterior surface 24. Positioned about the exterior surface 24 is a lock ring 28. The stop ring 26 and the lock ring 28 are positioned at predetermined locations between the first end portion 16 and the second end portion 18. The stop ring 26 and the lock ring 28 may be permanently affixed in relation to the body 20, or adjustably attached using conventional mechanical fastening methods. A collar 30 is slideably attached about the stop ring 26 of the body 20. The collar 30 includes a wall 32 and a top ring 34. The wall 32 includes an interior surface 35 adapted to slide along the stop ring 26. The top ring 34 is adapted to engage the stop ring 26 and prevent the collar 30 from disengaging the body 20. The top ring 34 may be mechanically attached to the collar 30 for assembly purposes or alternatively machined into the collar 30. The collar 30 includes a bottom surface 36 opposite the top ring 34. The bottom surface 36 is substantially flat and adapted to engage the surface 12 of the road or racetrack. A preload spring 38 is disposed between the lock ring 28 and top ring 34. The preload spring 38 acts to control the amount of force that is transmitted from the housing 14 to the contact assembly 15, when the measuring device 10 is being biased toward the surface 12. A lock mechanism (not shown) may be positioned in relation to the housing 14 and contact assembly 15 to prevent movement of the contact assembly 15 toward to the surface 12 during actuation of the measuring device 10.

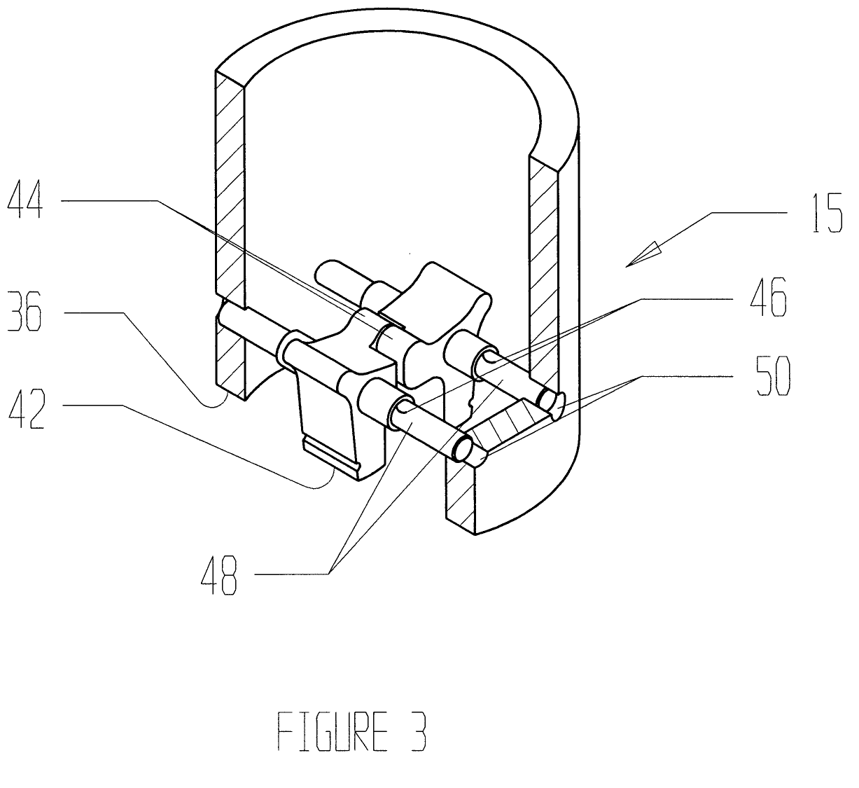

Referring now to FIG. 3, a detailed view of the contact assembly 15 of the present invention is shown. At least one contact lever 40 is moveably disposed within the contact assembly 15. As illustrated, a pair of contact levers 40 is arranged in a manner to permit movement along the surface 12. The contact levers 40 include a contact surface 42, positioned to engage the surface 12 being measured. As disclosed the contact surface 42 is manufactured from wear resistant material such as steel. However it may be found through to manufacture the contact surface 42 from materials such as non-ferrous, composite, or ceramic. Contact surface 42 may include a surface texture 43 such as cross hatched, shot peened, grooved, smooth or other formation positioned thereon. As disclosed the contact levers 40 additionally include a shoulder 44 and a bore 46. The bore 46 is arranged to engage a shaft 48 and a pair of holes 50 provided in the contact assembly 15. The shoulder 44 is adapted to be acted on by an actuator 52 causing rotation of the contact levers 40 about the shaft 48. Rotation of the contact levers 40, in turn causes movement of the contact surface 42 along the surface 12.

As illustrated the actuator 52 is a hydraulic actuator 56. It should be noted that numerous types of actuators 52 may be used to engage the contact assembly 15. Types of actuators 52 include but are not limited to, a drive screw, a pneumatic actuator and a linear motor. It should be noted that the method of actuation must be aggressively controllable, allowing a smooth and consistent application of force to the contact assembly 15. The sudden actuation at a rate that is not properly controlled may result in a spike (higher than actual indication of traction). Additionally, the actuator must be capable of providing measurable indication of the force being applied to the contact assembly 15. An adjustment mechanism 54 is positioned between the contact assembly 15 and the actuator 52. The adjustment mechanism 54 acts to control the distance between the actuator 52 and shoulder 44 of the contact lever 40. Movement of the actuator 52 in a direction toward the shoulder 44 causes the contact surface 42 to be moved along the surface 12.

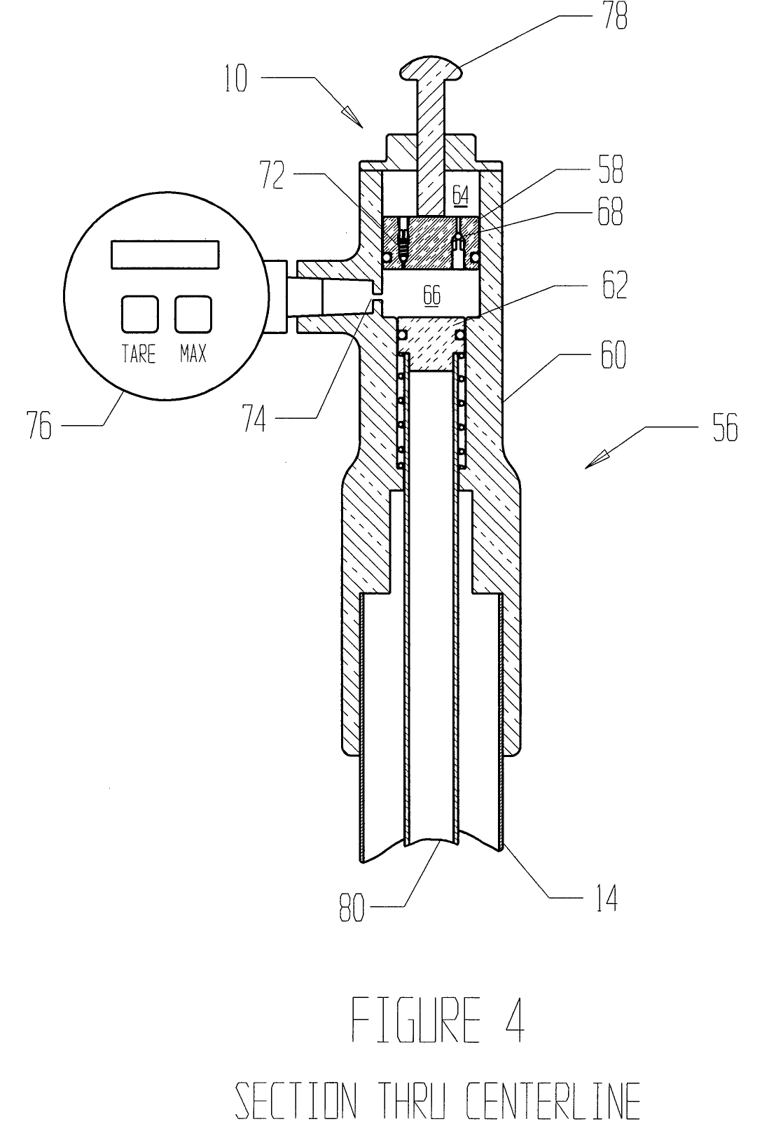

Referring now to FIG. 4, the hydraulic actuator 56 is illustrated. The hydraulic actuator 56 includes an input piston 58 and an output piston 62 and a fluid reservoir 64 disposed within an actuator housing 64. As disclosed, the input piston 58 is positioned between the reservoir 64 and the output piston 62. A fluid coupling 66 is disposed between the input piston 58 and output piston 62. A check valve 68 and a relief valve 72 are disposed in the input piston 58. The check valve 68 may permit flow of hydraulic fluid in a direction from the reservoir 64 toward the fluid coupling 66. The relief valve 72 may permit flow of hydraulic fluid in a direction from the fluid coupling 66 toward the reservoir 64. The check valve 66 and the relief valve 72 are sized to permit fluid flow in each respective direction at predetermined fluid pressure. An orifice 74 is provided between the fluid coupling 66 and an indicator 76. The indicator 76 is adapted to provide a value related to the amount of force required to move the contact surface 42 along the surface 12. As illustrated the indicator 76 is a pressure gauge having a high pressure “hold” feature adapted to preserve the highest value indicated by the gauge. Other types of indicators may be other known types of indicators such as electronic sensors and displays. The input piston 58 includes a linkage 78 adapted to be acted on by an external force, such as a manual force exerted by a person operating the measuring device 10. The output piston 62 includes an output linkage 80 adapted to act on the shoulder 44 of the contact lever 40.

The measuring device 10 may include common devices such as thermometer, moisture sensor, barometer and light sensor adapted to provide information relative to surface and atmospheric conditions. Examples of such devices may be found in an electronic home weather station.

### INDUSTRIAL APPLICABILITY

In operation the measuring device 10 of the present invention is placed against the surface 12 with the bottom surface 36 of the collar 30 adjacent the surface 12. In this position, the housing 14 is substantially perpendicular to the surface 12. A manual force is applied to the housing 14 to cause the contact levers 40 to engage the surface 12. The preload spring 38 thereby is compressed causing contact levers 40 to engage the surface 12 with a predetermined and repeatable force. The actuator 52 is then actuated causing the contact surface 42 of the contact lever 40 to move along the surface 12. The force required to move the contact surface 42 is thereby displayed on the indicator 76. By providing multiple readings at predetermined intervals, and at various locations on the surface 12 the team may monitor changes in the tractive condition of the surface 12.

In operation, the present invention provides an indication of the surface 12. Of utmost importance is the ability of the measuring device 10 to provide a consistent and repeatable indication at the specific time that the measurement is taken. By using the measuring device repeatedly over the course of a day, it is possible to monitor changes in the condition of the surface 12 and advise a driver of those changes.

It will be apparent to those skilled in the art that various modifications and variations can be made to the disclosed measuring device. Other embodiments will be apparent to those skilled in the art from consideration of the specification and practice of the disclosed measuring device. It is intended that the specification and examples be considered as exemplary only, with a true scope being indicated by the following claims and their equivalent.

What is claimed is:

1. A measurement device for indication of a tractive condition of a surface, comprising:
a contact lever having a contact surface, said contact surface adapted to engage said surface;
an actuator adapted to move said contact surface of said contact lever in relation to said surface; and
an output device adapted to provide a quantitative indication representative of the tractive condition of said surface.

2. The measurement device of claim 1, wherein said actuator is a hydraulic device.

3. The measurement device of claim 2, wherein said hydraulic device includes an orifice adapted to control the rate of movement of said contact lever.

4. The measurement device of claim 1, wherein said output device is a pressure gauge.

5. The measurement device of claim 1, wherein said output device is an electronic sensor adapted to transmit a discrete signal.

6. The measurement device of claim 5, wherein said discrete signal is received by a microprocessor.

7. The measurement device of claim 6, wherein said actuator is a drive screw.

8. The measurement device of claim 1, wherein said contact lever is rotatably positioned in a contact assembly.

9. The measurement device of claim 8, wherein said contact assembly is positioned within a housing.

10. The measurement device of claim 9, including a collar and a preload spring slidably disposed about the housing.

11. The measurement device of claim 10, wherein said preload spring acts to control the amount of force that is transmitted from the housing to the contact assembly, when the measuring device is being biased toward the surface.

12. A method of indicating the tractive condition of a surface comprising the steps of:
engaging said surface with a measuring device;
actuating said measuring device against said surface; and
receiving an output from said measuring device, wherein said output quantifies the condition of said surface.

13. The method of claim 12, wherein said surface is a road surface.

14. The method of claim 12, wherein said surface is a racetrack.

15. The method of claim 12, including the step of biasing said measuring device against said surface.

16. The method of claim 12, wherein the output signal can be one of hydraulic or electronic.

17. The method of claim 12, wherein the step of receiving said signal includes converting said signal to a numeric output.
